(19) United States
(12) Patent Application Publication
(10) Pub. No.: US 2021/0184266 A1
(43) Pub. Date: Jun. 17, 2021

(54) METHOD OF PRODUCING SECONDARY BATTERY

(71) Applicant: TOYOTA JIDOSHA KABUSHIKI KAISHA, Toyota-shi (JP)

(72) Inventor: Atsushi SUGIHARA, Toyota-shi (JP)

(73) Assignee: TOYOTA JIDOSHA KABUSHIKI KAISHA, Toyota-shi (JP)

(21) Appl. No.: 16/996,292

(22) Filed: Aug. 18, 2020

(30) Foreign Application Priority Data
Dec. 11, 2019 (JP) 2019-223610

(51) Int. Cl. H01M 10/0587; B23K 11/11

(52) U.S. Cl. CPC H01M 10/0587; B23K 2101/36; B23K 11/115

(57) ABSTRACT

A method of producing a secondary battery includes an electrode body forming process and a resistance welding process. In the electrode body forming process, a sheet-like positive electrode and negative electrode are wound in an overlapping manner with a separator therebetween to form a flat wound electrode body. In the resistance welding process, a current collector terminal is bonded to at least one of a pair of uncoated parts which are positioned at both ends of the wound electrode body in a winding axis direction and to which no electrode mixture is applied by resistance welding. The resistance welding process is performed while metal members are brought into contact with the uncoated parts.

### INCORPORATION BY REFERENCE

The disclosure of Japanese Patent Application No. 2019-223610 filed on Dec. 11, 2019 including the specification, drawings and abstract is incorporated herein by reference in its entirety.

### BACKGROUND

### 1. Technical Field

The present disclosure relates to a method of producing a secondary battery.

### 2. Description of Related Art

Secondary batteries are widely used as portable power supplies for computers, mobile terminals, and the like or power supplies for driving vehicles such as electric vehicles (EV), hybrid vehicles (HV), and plug-in hybrid vehicles (PHV). As an example of a secondary battery, there is a secondary battery including a wound electrode body. The wound electrode body is formed in a flat shape in which a sheet-like positive electrode and negative electrode are wound with a separator therebetween. Uncoated parts to which no electrode mixture is applied are formed at both ends of the wound electrode body in a winding axis direction. A current collector terminal is used to electrically connect the wound electrode body to the external terminal. The current collector terminal is bonded to the uncoated part of the wound electrode body and electrically connected to the external terminal.

For example, in a method of producing a secondary battery described in Japanese Unexamined Patent Application Publication No. 2014-26927 (JP 2014-26927 A), a current is caused to flow through a pair of electrodes when an uncoated part of a wound electrode body and a current collector terminal are interposed between the pair of electrodes and thus the current collector terminal is bonded to the uncoated part by resistance welding.

### SUMMARY

When the current collector terminal is bonded to the uncoated part by resistance welding, the temperature of the welded part may rise excessively. The excessive rise in the temperature of the welded part can cause problems, for example, thermal contraction of the separator in the wound electrode body.

An exemplary object of the present disclosure is to provide a method of producing a secondary battery through which the effect of an excessive rise in the temperature of a welded part is appropriately reduced when a current collector terminal is bonded to an uncoated part by resistance welding.

A method of producing a secondary battery according to an aspect disclosed here includes an electrode body forming process in which a sheet-like positive electrode and negative electrode are wound in an overlapping manner with a separator therebetween to form a flat wound electrode body and a resistance welding process in which a current collector terminal is bonded to at least one of a pair of uncoated parts which are positioned at both ends of the wound electrode body in a winding axis direction and to which no electrode mixture is applied by resistance welding, wherein the resistance welding process is performed while metal members are brought into contact with the uncoated parts.

When the resistance welding process is performed while the metal members are brought into contact with the uncoated parts, heat generated by resistance welding is likely to escape to the metal members. As a result, since an excessive rise in the temperature of the welded part is appropriately curbed, a possibility of the separator thermally contracting and the like decrease.

The resistance welding process may be performed while the uncoated parts are interposed between the pair of metal members which are brought into contact with the uncoated parts from both sides in the thickness direction. In this case, compared to when the metal members are simply brought into contact with the surface of the uncoated parts, a gap between a plurality of current collectors laminated in the uncoated parts is reduced. Therefore, heat generated in the welded part is more easily transmitted to the metal members. Therefore, an excessive rise in the temperature of the welded part is more effectively curbed. However, even if metal members are simply brought into contact with uncoated parts without the uncoated parts being interposed between the pair of metal members, it is possible to curb an excessive rise in the temperature of the welded part.

In a preferable aspect of the method of producing a secondary battery disclosed here, the resistance welding process is performed while metal members are brought into contact with a part of the uncoated part adjacent to the welded part to which the current collector terminal is resistance-welded. In this case, heat generated in the welded part is more likely to escape to the metal members in contact with the part adjacent to the welded part. Therefore, an excessive rise in the temperature of the welded part is more effectively curbed.

Here, when the resistance welding process is performed, the welded part may be separated from the metal members that come in contact with a part adjacent to the welded part. In this case, compared to when the metal members are in contact with the welded part, a current applied during resistance welding is unlikely to leak to the metal members. Therefore, an excessive rise in the temperature of the welded part is curbed while a decrease in efficiency of resistance welding due to current leakage is minimized.

When the welded part and the metal member are separated from each other, a distance between the welded part and the metal member may be 3 mm or more and 12 mm or less. When the distance between the welded part and the metal member is set to 3 mm or more, a current during resistance welding is unlikely to leak to the metal member. In addition, when a distance between the welded part and the metal member is set to 12 mm or less, heat generated in the welded part is likely to escape to the metal member. Therefore, when the distance is set to 3 mm or more and 12 mm or less, the current collector terminal is bonded to the uncoated part more appropriately.

In a preferable aspect of the method of producing a secondary battery disclosed here, within the uncoated part, the welded part is formed at a position within 12 mm from an end on the side of the external terminal connected to the current collector terminal. In addition, the resistance welding process is performed while the metal members are brought into contact with a part of the uncoated part adjacent to the side opposite to the external terminal of the welded part.

In this case, since a distance from the end on the side of the external terminal of the uncoated part to the welded part is shortened, it is easy to shorten the length of the current collector terminal. Therefore, it is easy to reduce the amount of the material of the current collector terminal. On the other hand, in a method of producing a secondary battery of the related art, when a distance from the end on the side of the external terminal of the uncoated part to the welded part is shortened, a heat capacity around the welded part decreases and heat generated in the welded part is unlikely to escape to the surroundings. On the other hand, in an aspect of the method of producing a secondary battery according to the present disclosure, the resistance welding process is performed while metal members are in contact with the side opposite to the external terminal of the welded part. Therefore, an excessive rise in the temperature of the welded part is appropriately curbed while the distance from the end on the side of the external terminal of the uncoated part to the welded part is shortened.

However, the distance from the end on the side of the external terminal of the uncoated part to the welded part may be larger than 12 mm. In this case, when the resistance welding process is performed while the metal members are brought into contact with the uncoated part, an excessive rise in the temperature of the welded part is appropriately curbed.

In a preferable aspect of the method of producing a secondary battery disclosed here, irregularities are formed in a part of the metal members in contact with the uncoated part. In this case, compared to when no irregularities are formed in the metal member, a contact area between the metal member and the uncoated part increases. Therefore, heat generated in the welded part is more likely to escape to the metal members.

### BRIEF DESCRIPTION OF THE DRAWINGS

Features, advantages, and technical and industrial significance of exemplary embodiments will be described below with reference to the accompanying drawings, in which like signs denote like elements, and wherein:

FIG. 1 is a cross-sectional view schematically showing an internal structure of a secondary battery 1 of the present embodiment;

FIG. 2 is a schematic view showing a configuration of an electrode body 20 of the secondary battery 1 of the present embodiment;

FIG. 3 is a partial cross-sectional view of the wound electrode body 20 when viewed from the side of an uncoated part 62A when a resistance welding process is performed; and

FIG. 4 is a graph showing results of an evaluation test using a comparative example and an example.

### DETAILED DESCRIPTION OF EMBODIMENTS

Hereinafter, one typical embodiment of the present disclosure will be described in detail with reference to the drawings. Components other than those specifically mentioned in this specification that are necessary for implementation can be recognized by those skilled in the art as design matters based on the related art in the field. The present disclosure can be implemented based on the content disclosed in this specification and common general technical knowledge in the field. Here, in the following drawings, members and portions having the same functions are denoted by the same reference numerals for explanation. In addition, the sizes (a length, a width, a thickness and the like) in the drawings do not reflect actual sizes.

In this specification, “battery” is a term that generally refers to a power storage device from which electric energy can be extracted and the concept includes a primary battery and a secondary battery. “Secondary battery” generally refers to a power storage device that can be repeatedly charged and discharged, and includes a so-called storage battery (that is, a chemical battery) such as a lithium ion secondary battery, a nickel hydride battery, and a nickel cadmium battery and also a capacitor (that is, a physical battery) such as an electric double layer capacitor. Hereinafter, a method of producing a secondary battery according to the present disclosure will be described in detail using a method of producing a flat rectangular lithium ion secondary battery which is a type of secondary battery as an example. However, the method of producing a secondary battery according to the present disclosure is not intended to be limited to those described in the following embodiment.

<Configuration of Secondary Battery>

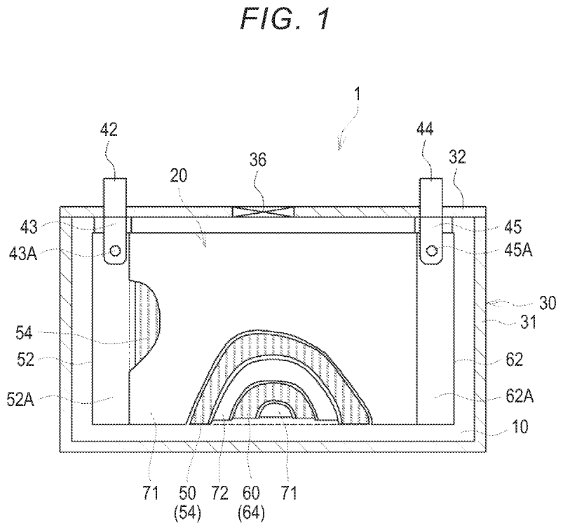

A secondary battery 1 shown in FIG. 1 is a sealed lithium ion secondary battery including a wound electrode body 20, a non-aqueous electrolytic solution 10, and a battery case 30. The battery case 30 stores the wound electrode body 20 and the non-aqueous electrolytic solution 10 therein in a sealed state. The battery case 30 in the present embodiment has a flat rectangular shape. The battery case 30 includes a box-shaped main body 31 having an opening at one end and a plate-like lid 32 that blocks the opening of the main body. In the battery case 30 (specifically, the lid 32 of the battery case 30), a positive electrode external terminal 42 and a negative electrode external terminal 44 for external connection and a safety valve 36 are provided. When the internal pressure of the battery case 30 increases to a predetermined level or more, the safety valve 36 releases the internal pressure. In addition, in the battery case 30, an inlet (not shown) for injecting the non-aqueous electrolytic solution 10 into the inside is provided. Regarding the material of the battery case 30, for example, a lightweight metal material having favorable thermal conductivity such as aluminum is used. However, it is also possible to change the configuration of the battery case. For example, a flexible laminate may be used as the battery case.

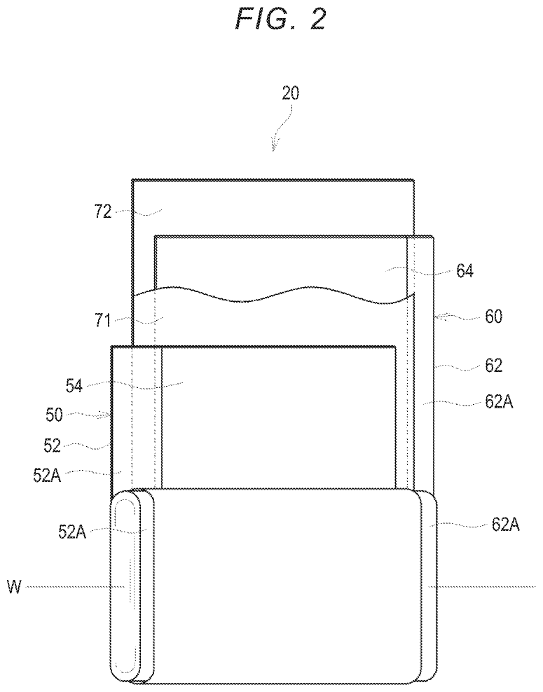

As shown in FIG. 2, in the wound electrode body (hereinafter simply referred to as an “electrode body”) 20 of the present embodiment, an elongated positive electrode (positive electrode sheet) 50, an elongated first separator 71, an elongated negative electrode (negative electrode sheet) 60, and an elongated second separator 72 are wound in an overlapping manner Specifically, in the positive electrode 50, an electrode mixture (positive electrode active material layer) 54 is applied to one surface or both surfaces (both surfaces in the present embodiment) of an elongated positive electrode current collector 52 in the longitudinal direction. In the negative electrode 60, an electrode mixture (negative electrode active material layer) 64 is applied to one surface or both surfaces (both surfaces in the present embodiment) of an elongated negative electrode current collector 62 in the longitudinal direction. Uncoated parts 52A and 62A are positioned at both ends of the wound electrode body 20 in a direction of a winding axis W (a sheet width direction orthogonal to the longitudinal direction). The uncoated part 52A is a part to which the electrode mixture 54 is not applied and at which the positive electrode current collector 52 is exposed. A positive electrode current collector terminal 43 (refer to FIG. 1) is bonded to the uncoated part 52A at a welded part 43A. The positive electrode external terminal 42 (refer to FIG. 1) is electrically connected to the positive electrode current collector terminal 43. In addition, the uncoated part 62A is a part to which the electrode mixture 64 is not applied and at which the negative electrode current collector 62 is exposed. A negative electrode current collector terminal 45 (refer to FIG. 1) is bonded to the uncoated part 62A at a welded part 45A. The negative electrode external terminal 44 (refer to FIG. 1) is electrically connected to the negative electrode current collector terminal 45.

Regarding materials and members constituting the positive and negative electrodes of the electrode body 20, those used in general secondary batteries in the related art can be used without limitation. For example, regarding the positive electrode current collector 52, one used as a positive electrode current collector of this type of secondary battery can be used without particular limitation. Typically, a metallic positive electrode current collector having favorable conductivity is preferable. For example, a metal material such as aluminum, nickel, titanium, or stainless steel can be used as the positive electrode current collector 52. An aluminum foil is used as the positive electrode current collector 52 of the present embodiment. Examples of a positive electrode active material of the positive electrode active material layer 54 include lithium mixed metal oxides having a layered structure or spinel structure (for example, LiNi_{1/3}Co_{1/3}Mn_{1/3}O₂, LiNiO₂, LiCoO₂, LiFeO₂, LiMn₂O₄, LiNi_{0.5}Mn_{1.5}O₄, LiCrMnO₄, or LiFePO₄). The positive electrode active material layer 54 can be formed by dispersing a positive electrode active material and a material used according to necessity (a conductive material, a binder, or the like) in an appropriate solvent (for example, N-methyl-2-pyrrolidone: NMP) to prepare a paste (or a slurry) composition, applying an appropriate amount of the composition to the surface of the positive electrode current collector 52, and performing drying. In the present embodiment, a ternary positive electrode active material, acetylene black (AB) as a conductive material, and polyvinylidene fluoride (PVDF) as a binder are contained in the positive electrode active material layer.

Regarding the negative electrode current collector 62, one used as a negative electrode current collector of this type of secondary battery can be used without particular limitation. Typically, a metallic negative electrode current collector having favorable conductivity is preferable, for example, copper (for example, a copper foil) or an alloy mainly containing copper can be used. A copper foil is used as the negative electrode current collector 62 of the present embodiment. Examples of negative electrode active materials of the negative electrode active material layer 64 include a particulate (or spherical or scaly) carbon material having a graphite structure (layered structure) in at least a part, lithium transition metal composite oxides (for example, a lithium titanium composite oxide such as Li₄Ti₅O₁₂), and lithium transition metal composite nitrides. The negative electrode active material layer 64 can be formed by dispersing a negative electrode active material and a material used according to necessity (a binder or the like) in an appropriate solvent (for example, deionized water) to prepare a paste (or slurry) composition, applying an appropriate amount of the composition to the surface of the negative electrode current collector 62, and performing drying. In the present embodiment, a graphite negative electrode active material, styrene butadiene rubber (SBR) as a binder, and carboxymethyl cellulose (CMC) as a thickener are contained in the negative electrode active material layer 64.

Regarding the first separator 71 and the second separator 72, a separator made of a porous sheet known in the related art can be used without particular limitation. For example, a porous sheet (a film, a non-woven fabric, and the like) made of a polyolefin resin such as polyethylene (PE) or polypropylene (PP) may be exemplified. Such a porous sheet may have a single-layer structure or a multiple-layer structure including two or more layers (for example, a 3-layer structure in which a PP layer is laminated on both surfaces of a PE layer). In addition, the porous sheet may have a configuration in which a porous heat-resistant layer is provided on one surface or both surfaces. The heat-resistant layer may be, for example, a layer containing an inorganic filler and a binder (also referred to as a filler layer). Regarding the inorganic filler, for example, alumina, boehmite, silica and the like can be preferably used.

The non-aqueous electrolytic solution 10 stored in the battery case 30 together with the electrode body 20 contains a supporting salt in an appropriate non-aqueous solvent, and a non-aqueous electrolytic solution known in the related art can be used without particular limitation. Regarding the non-aqueous solvent, for example, ethylene carbonate (EC), diethyl carbonate (DEC), dimethyl carbonate (DMC), or ethyl methyl carbonate (EMC) can be used. In addition, regarding the supporting salt, for example, a lithium salt (for example, LiBOB or LiPF₆) can be suitably used. In the present embodiment, LiBOB is used.

<Overview of Production Method>

Next, an overview of a method of producing the secondary battery 1 of the present embodiment will be described. The method of producing the secondary battery 1 of the present embodiment includes an electrode body forming process and a resistance welding process. In the electrode body forming process, the wound electrode body 20 is formed. In addition, in the resistance welding process of the present embodiment, a current collector terminal is bonded to at least one of the pair of uncoated parts 52A and 62A by resistance welding.

As described above, a copper foil is used as the negative electrode current collector 62 of the wound electrode body 20 of the present embodiment. Here, when the negative electrode current collector terminal 45 is bonded to the uncoated part 62A by ultrasonic welding or the like, a part of the copper foil constituting the negative electrode current collector 62 may be scattered as a foreign substance during ultrasonic welding. When a part of the copper foil remains as a foreign substance in the secondary battery 1, problems such as short circuiting can occur. Therefore, in the resistance welding process in the present embodiment, the negative electrode current collector terminal 45 is bonded to the uncoated part 62A by resistance welding in which a copper foil is unlikely to scatter as a foreign substance.

In addition, the method of producing the secondary battery 1 of the present embodiment includes an ultrasonic welding process in addition to the electrode body forming process and the resistance welding process. In the ultrasonic welding process, the positive electrode current collector terminal 43 is bonded to the uncoated part 52A by ultrasonic welding. Here, either the resistance welding process or the ultrasonic welding process may be performed first.

<Electrode Body Forming Process>

In the electrode body forming process of the present embodiment, as shown in FIG. 2, the elongated positive electrode 50, the elongated first separator 71, the elongated negative electrode 60, and the elongated second separator 72 are wound in an overlapping manner to form the flat wound electrode body 20. In the wound electrode body 20, for example, the positive electrode 50, the first separator 71, the negative electrode 60, and the second separator 72 may be wound around a winding core having a flat cross section orthogonal to the winding axis W and formed in a flat shape. In addition, the wound electrode body 20 may be formed in a flat shape, for example, by winding the positive electrode 50, the first separator 71, the negative electrode 60, and the second separator 72 in a cylindrical shape and then crushing them in a side direction.

<Resistance Welding Process>

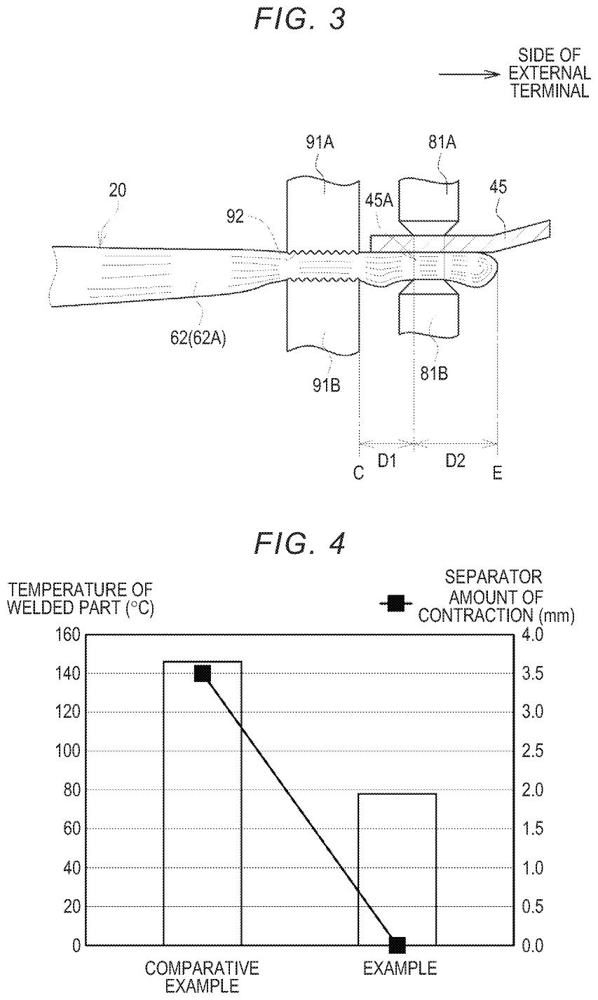

The resistance welding process in the present embodiment will be described with reference to FIG. 3. In resistance welding, a pair of electrode rods 81A and 81B are used. In the uncoated part 62A of the wound electrode body 20, a plurality of negative electrode current collectors 62 that are exposed without being coated with the electrode mixture 64 are laminated. When resistance welding is performed, while a plate surface of the substantially plate-like negative electrode current collector terminal 45 is in surface contact with the surface of the uncoated part 62A, the negative electrode current collector terminal 45 and the uncoated part 62A are interposed between the pair of electrode rods 81A and 81B and compressed. As an example, in the present embodiment, the pressure during compression by the pair of electrode rods 81A and 82B is about 1.1 kN. Next, when a current flows in the pair of electrode rods 81A and 81B (as an example, a current of 7.5 kA in the present embodiment) for a predetermined time (for 20 ms in the present embodiment), the welded part 45A that is melted due to heat generation resulting from current flowing is formed in a part interposed between the pair of electrode rods 81A and 81B. As a result, the negative electrode current collector terminal 45 is bonded to the uncoated part 62A.

In the resistance welding process of the present embodiment, while metal members 91A and 91B are in contact with the uncoated part 62A, resistance welding is performed by the pair of electrode rods 81A and 81B. When resistance welding is performed without bringing the metal members 91A and 91B into contact with the uncoated part 62A, heat generated in the welded part 45A is unlikely to escape into the surroundings, and the temperature of the welded part 45A may rise excessively. When the temperature of the welded part 45A excessively rises, it may cause problems such as thermal contraction of the first separator 71 and the second separator 72. On the other hand, in the resistance welding process of the present embodiment, heat generated in the welded part 45A by resistance welding is likely to escape into the metal members 91A and 91B in contact with the uncoated part 62A. As a result, an excessive rise in the temperature of the welded part 45A is appropriately curbed.

In the resistance welding process of the present embodiment, resistance welding is performed by the electrode rods 81A and 81B while the uncoated part 62A is interposed between the pair of metal members 91A and 91B which are (compressed and) brought into contact with the uncoated parts 62A from both sides in the thickness direction. Therefore, resistance welding is performed while a gap between the plurality of negative electrode current collectors 62 laminated in the uncoated part 62A is reduced. Accordingly, heat generated in the welded part 45A is easily transmitted to the pair of metal members 91A and 91B.

In the resistance welding process of the present embodiment, resistance welding by the pair of electrode rods 81A and 81B is performed while the metal members 91A and 91B are brought into contact with a part of the uncoated part 62A adjacent to the welded part 45A. Therefore, compared to when the welded part 45A and the metal members 91A and 91B are not adjacent to each other but are largely separated, heat generated in the welded part 45A is more likely to escape into the metal members 91A and 91B.

In the resistance welding process of the present embodiment, the welded part 45A (that is, a part interposed between the pair of electrode rods 81A and 81B) and the metal members 91A and 91B arranged in a part adjacent to the welded part 45A are separated without contact with each other. Therefore, a current applied to the pair of electrode rods 81A and 81B during resistance welding is unlikely to leak to the metal members 91A and 91B. Therefore, an excessive rise in the temperature of the welded part 45A is curbed while a decrease in efficiency of resistance welding due to current leakage is minimized.

In the present embodiment, a distance D1 between the welded part 45A and the metal members 91A and 91B is set to 3 mm or more and 12 mm or less. When the distance D1 is set to 3 mm or more, a current is unlikely to leak to the metal members 91A and 91B during resistance welding. In addition, when the distance D1 is set to 12 mm or less, heat generated in the welded part 45A is likely to escape into the metal members 91A and 91B. Therefore, the negative electrode current collector terminal 45 is bonded to the uncoated part 62A more appropriately.

In the present embodiment, within the uncoated part 62A of the wound electrode body 20, the welded part 45A is formed in a range in which a distance D2 from an end E (a right end in FIG. 3) on the side of the negative electrode external terminal 44 (refer to FIG. 1) connected to the negative electrode current collector terminal 45 is within 12 mm. In this case, since it is easy to shorten the length (length in the horizontal direction in FIG. 3) of the negative electrode current collector terminal 45, it is easy to reduce the amount of the material of the negative electrode current collector terminal 45. Here, in the present embodiment, a distance from the end E of the uncoated part 62A to the center of the welded part 45A is set to about 4 mm. In addition, in the present embodiment, like the welded part 45A of the negative electrode current collector terminal 45, the welded part 43A (refer to FIG. 1) of the positive electrode current collector terminal 43 is also formed within a range of 12 mm from the end of the uncoated part 52A on the side of the positive electrode external terminal 42. Therefore, it is easy to reduce the amount of the material of the positive electrode current collector terminal 43.

Here, when a distance from the end E of the uncoated part 62A on the side of the negative electrode external terminal 44 to the welded part 45A is shortened, the volume of the uncoated part 62A on the side of the negative electrode external terminal 44 is smaller than that of the welded part 45A. As a result, a heat capacity around the welded part 45A decreases and heat generated in the welded part 45A is unlikely to escape into the surroundings. On the other hand, in the resistance welding process of the present embodiment, the metal members 91A and 91B are brought into contact with a part of the uncoated part 62A adjacent to the side opposite to the negative electrode external terminal 44 (refer to FIG. 1) of the welded part 45A. Therefore, in the present embodiment, an excessive rise in the temperature of the welded part 45A is appropriately curbed while a distance from the end E of the uncoated part 62A on the side of the negative electrode external terminal 44 to the welded part 45A is shortened.

Here, in the present embodiment, the width (the width in the vertical direction in FIG. 2, and the width in the horizontal direction in FIG. 3) of the wound electrode body 20 in the height direction orthogonal to the winding axis W (refer to FIG. 2) is set to 40 mm or more and 90 mm or less (for example, about 50 mm). In the present embodiment, a contact position C of the metal members 91A and 91B on the side of the negative electrode external terminal 44 with respect to the uncoated part 62A is set closer to the negative electrode external terminal 44 (the end E) than the center of the uncoated part 62A in the inverse direction. Therefore, a distance from the end E of the uncoated part 62A on the side of the negative electrode external terminal 44 to the welded part 45A is shortened and the distance D1 between the welded part 45A and the metal members 91A and 91B is also shortened. Therefore, it is easy to reduce the amount of the material of the negative electrode current collector terminal 45 and heat generated in the welded part 45A is likely to escape into the metal members 91A and 91B.

In the present embodiment, irregularities 92 are formed in a part of the metal members 91A and 91B in contact with the uncoated part 62A. Therefore, compared to when the irregularities 92 are not formed in the metal members 91A and 91B, a contact area between the metal members 91A and 91B and the uncoated part 62A increases. Therefore, heat generated in the welded part 45A is more likely to escape into the metal members 91A and 91B.

### Examples

Results of an evaluation test using an example and a comparative example will be described with reference to FIG. 4. Materials, sizes and the like of the secondary battery of the example and the secondary battery of the comparative example were the same as those of the secondary battery 1 described in the above embodiment. In a procedure of producing the secondary battery of the example, according to the resistance welding process in the above embodiment, resistance welding was performed while the metal members 91A and 91B were brought into contact with the uncoated parts 62A. On the other hand, in a procedure of producing the secondary battery of the comparative example, the metal members 91A and 91B were not used during resistance welding. That is, the secondary battery of the example and the secondary battery of the comparative example were different only in use of the metal members 91A and 91B in the production procedure and were the same in other production conditions, materials, sizes, and the like. In each of the example and the comparative example, the temperature of the welded part 45A during resistance welding and the contraction amounts of the separators 71 and 72 before and after resistance welding were measured. Measurement results are shown in FIG. 4. In FIG. 4, the temperature of the welded part is shown as a bar graph and the contraction amounts of the separators are shown as black marks.

As shown in FIG. 4, in the secondary battery of the comparative example, due to the effect caused when the temperature of the welded part increased to about 145° C., the contraction amount of the separator also reached a large value (about 3.5 mm). On the other hand, in the secondary battery of the example, the temperature of the welded part reached an appropriate temperature (about 79° C.) and the contraction amount of the separator was 0 mm Based on the above results, it was found that, when the resistance welding process was performed while metal members were brought into contact with the uncoated parts, an excessive rise in the temperature of the welded part was appropriately curbed and the separator was unlikely to thermally contract.

The technology disclosed in the above embodiment is only an example. Therefore, it is possible to change the technology exemplified in the above embodiment. For example, in the embodiment, when the negative electrode current collector terminal 45 was bonded to the uncoated part 62A by resistance welding, the metal members 91A and 91B were used. In addition, the positive electrode current collector terminal 43 was bonded to the uncoated part 52A by ultrasonic bonding. However, when the positive electrode current collector terminal 43 is bonded to the uncoated part 62A by resistance welding, the metal members 91A and 91B may be used as in the above embodiment.

While the present disclosure has been described above in detail with reference to specific embodiments, these are only examples, and do not limit the scope of the claims. The technology described in the scope of the claims includes various modifications and alternations of the above embodiments.

What is claimed is:

1. A method of producing a secondary battery, comprising:
an electrode body forming process in which a sheet-like positive electrode and negative electrode are wound in an overlapping manner with a separator therebetween to form a flat wound electrode body; and
a resistance welding process in which a current collector terminal is bonded to at least one of a pair of uncoated parts which are positioned at both ends of the wound electrode body in a winding axis direction and to which no electrode mixture is applied by resistance welding,
wherein the resistance welding process is performed while metal members are brought into contact with the uncoated parts.

2. The method according to claim 1, wherein the resistance welding process is performed while the metal members are brought into contact with a part of the uncoated part adjacent to a welded part to which the current collector terminal is resistance-welded.

3. The method according to claim 2,
wherein, within the uncoated part, the welded part is formed at a position within 12 mm from an end on the side of an external terminal connected to the current collector terminal, and
wherein the resistance welding process is performed while the metal members are brought into contact with a part of the uncoated part adjacent to the side opposite to the external terminal of the welded part.

4. The method according to claim 1, wherein irregularities are formed in a part of the metal members in contact with the uncoated part.
